(19) United States
(12) Patent Application Publication
(10) Pub. No.: US 2024/0075551 A1
(43) Pub. Date: Mar. 7, 2024

(54) LASER MATERIAL MACHINING ASSEMBLY

(71) Applicant: Fraunhofer-Gesellschaft zur Förderung der Angewandten Forschung E.V., München (DE)

(72) Inventor: Mario HESKER, Aachen (DE)

(21) Appl. No.: 18/262,465

(22) PCT Filed: Jan. 20, 2022
(86) PCT No.: PCT/EP2022/051237

§ 371 Date: Jul. 21, 2023

(30) Foreign Application Priority Data
Jan. 22, 2021 (DE) 102021101373.9
Jan. 20, 2022 (WO) PCT/EP2021/051237

(51) Int. Cl. B23K 26/067; B23K 26/06; B23K 26/0622; B23K 26/082; B23K 26/352

(52) U.S. Cl. CPC B23K 26/0676; B23K 26/0622; B23K 26/0643; B23K 26/0648; B23K 26/0652; B23K 26/082; B23K 26/352

(57) ABSTRACT

A laser material machining assembly has at least one laser beam source (5), a beam splitter (6), a modulating device with a plurality of acousto-optical modulators (4) and a dynamic beam deflection device (9). A collimated laser beam (10) is separated two-dimensionally into a plurality of sub-beams (1) by means of the beam splitter (6), said sub-beams running non-parallel to each other in at least one first dimension. An optical assembly is arranged between the beam splitter (6) and the modulating device in order to parallelise the sub-beams (1) in the first dimension. This optical assembly has an array of multiple prisms (12), are designed and arranged such that the sub-beams (1) are aligned in parallel to one another in the first dimension upon passing through the prisms (12) by means of a respective double diffraction. In this manner, the sub-beams (1) remain collimated in the acousto-optical modulators (4) so that the modulation in the acousto-optical modulators (4) can be carried out with maximum efficiency. The assembly can thus also be provided in more compact design.

### TECHNICAL FIELD OF APPLICATION

The present invention relates to a laser material machining assembly having least one laser beam source which emits a collimated laser beam, a beam splitter which splits the collimated laser beam two-dimensionally into a plurality of sub-beams, a modulating device for the mutually independent modulation of the individual sub-beams, and a dynamic beam deflection device, with which the sub-beams may be dynamically deflected in two directions perpendicularly to one another and guided over a machining plane.

Lasers are used for machining materials in many technical areas, for example for surface structuring, joining or cutting, or also in the field of generative manufacturing. The laser beam sources that are usable for laser material machining, in particular laser beam sources for ultrashort pulsed laser radiation, are being offered with steadily increasing energy capabilities. But the maximum energy for a laser spot on the workpiece is limited by the characteristics of the material. In order to use the high laser outputs efficiently, the total output is therefore often split into a number of sub-beams. A two-dimensional arrangement of the laser spots in the form of a matrix consisting of multiple rows and columns also enables material machining to be carried out rapidly. In order to maintain the flexibility of the machining process, it is essential to be able to switch each individual sub-beam on and off separately. Acousto-optical modulators (AOM) are often used for this. The switching speed and diffraction efficiency of the beam deflection in acousto-optical modulators are heavily dependent on the beam diameter, the angle of incidence of the beam on the crystal of the acousto-optical modulator, and the beam divergence. Therefore, the beam diameter must be kept as small as possible. The lower limit of the beam diameter is determined by the laser-induced damage threshold of the acousto-optical modulator.

### PRIOR ART

From S. Bruening et al., “Ultra-fast multi-spot-parallel processing of functional micro- and nano scale structures on embossing dies with ultrafast lasers”, Lasers in Manufacturing Conference 2017, for example, a laser material machining assembly is known with which a collimated laser beam from a laser beam source is split with a beam splitter into multiple sub-beams, which are then aligned parallel to each other via a Fourier lens and guided through a multichannel acousto-optical modulator. In this case, the beam is only split in one plane, with the result that a one-dimensional spot matrix is produced in the machining plane. The acousto-optical modulator is located in the intermediate focus of the relay optics created with the Fourier lens. With an assembly of this kind, two-dimensional spot matrices can be produced in the machining plane through correspondingly designed beam splitters and several multichannel acousto-optical modulators. Multichannel acousto-optical modulators can deflect several sub-beams propagating in a plane independently of each other. Accordingly, several multichannel modulators are needed for two-dimensional beam matrices. However, due to the nature of the construction, this makes the optic before the modulators very wide, which in turn necessitates the use of large, typically very expensive lenses to shape the beam. Furthermore, the sub-beams of the solution described above undergo divergence in the acousto-optical modulator due to the intermediate focus, resulting in the beam diameter being smaller in the middle of the modulator than at the input and output planes of the crystal. This reduces diffraction efficiency and increases the switching time of the acousto-optical modulator.

The problem addressed with the present invention is to describe a laser material machining assembly with a two-dimensional beam matrix that enables efficient modulation of the individual beams and can be constructed in a more compact form.

### SUMMARY OF THE INVENTION

The problem is solved with the laser material machining assembly according to claim 1. Advantageous variants of the assembly are the object of the dependent claims or may be discerned from the following description and the exemplary embodiments.

The suggested laser material machining assembly has at least one laser beam source, which emits a collimated laser beam, a beam splitter, a first optical assembly, a modulation device and a dynamic beam deflection device. The laser beam source may be in the form of a laser with upstream collimation optic, for example. Of course a laser that already emits a collimated laser beam may also be implemented. The beam splitter is designed such that it splits the collimated laser beam two-dimensionally, that is to say in two directions perpendicular to each other (in the following text also referred to as the x- and y-directions), into multiple sub-beams, which run non-parallel to each other at least in a first dimension. In this context, preferably at least 4 sub-beams running non-parallel are generated in the first dimension, that is to say at least one 4×N beam matrix (with N≥2). The first optical assembly is designed and arranged such that it aligns the sub-beams parallel to each other in the first dimension without disturbing the collimation of the individual sub-beams. The modulation device that adjoins the first optical assembly includes a plurality of acousto-optical modulators, which are of multichannel design in the first dimension, and with which the individual sub-beams may be modulated independently of each other. With the dynamic beam deflection device, e.g., a 2D galvanometer scanner, the sub-beams are then dynamically deflected in two directions perpendicular to each other, and guided over a machining plane. A focusing optic—an f-theta lens, for example—is typically arranged between the dynamic beam deflection device and the machining plane in order to focus the sub-beams onto the machining plane. Due to the modulation of the sub-beams in the acousto-optical modulators, the individual laser spots in the machining plane can be switched on and off independently of each other. The suggested assembly is characterized in that the first optical assembly has a plurality of first prisms, which are designed and arranged such that they align the sub-beams parallel to each other in the first dimension by double diffraction in each case (at the input and output surface of the prism) as they pass through the prisms. So this alignment of the sub-beams is brought about not by reflection on a prism face, but solely by the double diffraction. To each sub-beam, whose direction of propagation must be adjusted for parallel alignment, is assigned one of the prisms. Ideally, one common prism is used for all sub-beams in each beam plane that extends perpendicularly to the first dimension. Thus for example in the case of an 8×8 beam matrix, each prism deflects all 8 sub-beams of such a beam plane at the same time. Thus, in this case a total of 8 prisms are needed for 64 sub-beams.

By using prisms to parallelise the beams in the first dimension, corresponding to the x-direction in the following text, the collimation of the individual sub-beams is preserved, so that these sub-beams no longer exhibit divergence in the acousto-optical modulators. This makes it possible to achieve maximum switching efficiency in the acousto-optical modulators and the maximum possible power per sub-beam can be delivered into the machining plane. The use of the prisms to parallelise the beams also makes it possible to create a more compactly structured assembly than using relay optics. The prisms are preferably designed such that they can be bonded or attached to each other to form a stack without any additional components. In particular, the prisms have a trapezoidal footprint with parallel top and bottom faces, which in turn are parallel to the optical axis.

In an advantageous variant, the prisms are connected to each other, for example by adhesion or fastening, to form a rigid prism stack. This makes it considerably easier to adjust the assembly because the degrees of freedom of the prisms are reduced. The first optical assembly preferably also includes an afocal telescope, by which the beam diameter of the sub-beams is adjusted to the dimension needed (and still allowable) in the acousto-optical modulators. The afocal telescope is also used to separate the sub-beams that are diverging (but all still collimated) after the beam splitter more sharply (the angle of divergence is directly correlated to the reduction factor of the telescope). The beam splitters may be formed for example by at least one diffractive optical element (DOE), as is known from the state of the art.

The parallelisation of the sub-beams in the first dimension (x-direction) means that these sub-beams are parallel to each other when they reach the respective (in this dimension) multichannel acousto-optical modulator, whose crystal input face is arranged (by rotation about the x-axis) at the Bragg angle with respect to the incident sub-beams. In the second dimension, which is perpendicular to the first and will correspond in the rest of this text to the y-direction, the sub-beams are not parallelised. A multichannel acousto-optical is used for each beam plane with sub-beams that are parallelised in the first dimension. By using multiple beam deflection elements, in particular mirrors, between the beam splitter and the dynamic beam deflection device, a reticulated beam path can be created, which enables a still more compact construction of the assembly. In this case, the beam is preferably deflected in planes perpendicularly to the x-direction.

The dynamic beam deflection device preferably includes two mirrors which can be swivelled about axes that are perpendicular to each other, for example in the form of a two-dimensional galvanometer scanner.

In an advantageous variant, a second optical assembly is arranged between the modulation device and the dynamic beam deflection device, and serves to deflect the sub-beams exiting the modulation device in such a way that a mutual distance between the sub-beams in the machining plane is reduced or enlarged compared to a configuration that does not include this second optical assembly. In this way, the desired spot distance in the machining plane can be adjusted. In addition, this second optical assembly may also have the effect of pre-focusing or altering the beam diameters of the collimated sub-beams. For this purpose, a telescope is preferably installed in der second optical device, with an input and an output optic, between which again multiple prisms are arranged, by which the mutual distance of the sub-beams in the machining plane is reduced or enlarged correspondingly. These prisms too are preferably connected to each other rigidly to form a prism stack. In particular, to this end the prisms have a trapezoidal footprint with parallel top and bottom sides, which are again parallel to the optical axis. The individual sub-beams are again deflected in the same way as in the first optical assembly, by double diffraction as they pass through the respective prism. In this way, it is possible to select the spot distance and the spot size in the machining plane and/or on the workpiece independently of the distance between the channels in the respective multichannel acousto-optical modulator. The spot size is adjusted by dimensioning of the telescope, the spot distance by dimensioning of the prisms.

The suggested laser material machining assembly enables the efficient use of large laser outputs (>1 kW), for example in the ultrashort pulse range, with simultaneous reduction of the size of the optical elements needed and the installation space required therefor. Given the scalability and flexibility of the assembly, its industrial application potential lies mainly in surface structuring. This includes the production of functional surfaces for reducing friction on aircraft wings, for example, or the manufacture of print rollers. Since the scalability of the assembly allows more laser power to be applied to the workpiece based on a larger spot matrix (greater number of laser spots), the productivity of laser material machining applications is increased substantially.

### BRIEF DESCRIPTION OF THE DRAWING

In the following text, the suggested assembly will be explained again, in greater detail, with reference to exemplary embodiments thereof and in conjunction with the drawing. In the drawing:

FIG. 1 is a schematic representation of a spot matrix in a machining plane (a) and an example of such a matrix when machining a workpiece (b);

FIG. 2 is a schematic representation of the passage of a divergent beam bundle through an AOM (a) and a representation of the beam waist of a beam bundle inside an AOM (b);

FIG. 3 is a side view (a) of a laser material machining assembly according to the state of the art, and a top view (b) of said assembly;

FIG. 4 is a side view (a) of an exemplary design of the suggested laser material machining assembly, and a top view (b) of this assembly;

FIG. 5 is a side view of the beam passage through the prisms in an array according to FIG. 4;

FIG. 6 is an example of a design of the suggested assembly with reticulated beam paths in a top view as in FIG. 4b;

FIG. 7 is a side view of an exemplary design of the second optical assembly of the suggested assembly; and

FIG. 8 is an exemplary design, in which the beam course through the dynamic beam deflecting device of the suggested assembly is represented.

### WAYS OF IMPLEMENTING THE INVENTION

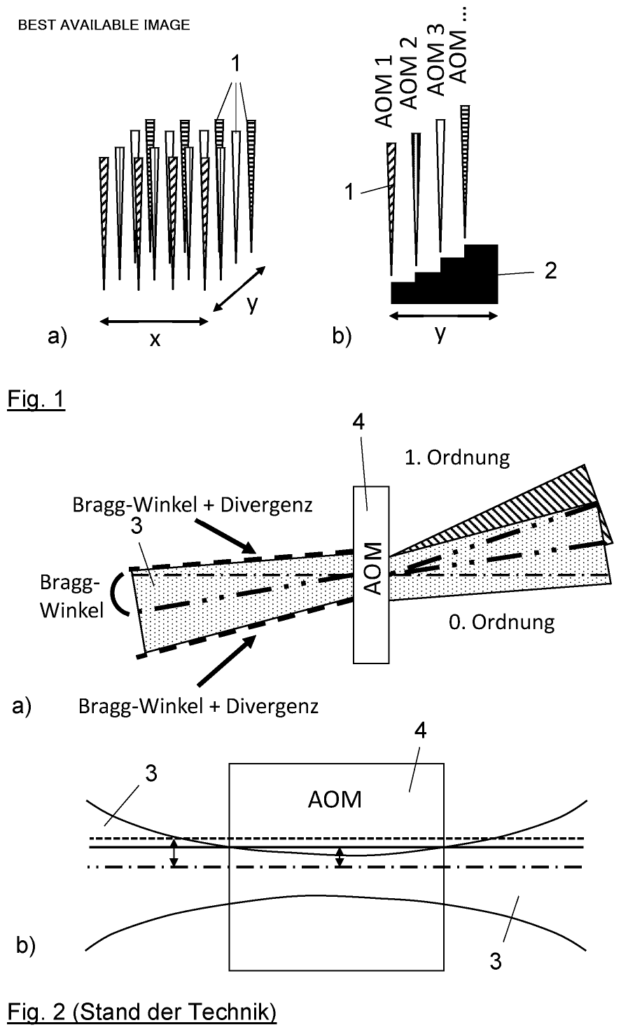

In order to enable the efficient use of the total power of the laser beam sources currently available, the emitted laser beam is often split into multiple sub-beams 1, by which a two-dimensional arrangement of laser spots is obtained, in the form of a matrix on the workpiece 2. FIG. 1a shows an example of such a two-dimensional spot matrix made from the individual sub-beams 1 in the machining plane. Each hatched area represents the sub-beams, each of which is individually engageable with a multichannel acousto-optical modulator (AOM). FIG. 1b outlines an exemplary machining of a workpiece 2, in which each row or line of the matrix (a hatched area for each) machines a plane of the workpiece 2. The entire matrix is deflected in x and y within a distance between the individual sub-beams. In order to be able to machine structures of any kind, it must be possible to switch each individual sub-beam 1 on and off separately. However, in the acousto-optical modulators used for this purpose, the switching speed and diffraction efficiency of the beam deflection depends to a great degree on the beam diameter, the angle of incidence between beam and AOM, and the divergence of the beam.

FIG. 2a further shows a divergent input beam 3, which is incident on an acousto-optical modulator 4 at the Bragg angle thereto, and can be switched by said modulator between the 0-th and the 1-st order. In a divergent input beam, the marginal beams deviate from the Bragg angle, thereby reducing the fraction of deflected power. When relay optics according to the prior art are used, with which the sub-beams are guided into the acousto-optical modulators, the beam diameter is smaller in the middle of the acousto-optical modulator 4 than at the edges, as is indicated with the beam 3 in FIG. 2b. The switching speed between the 0-th and the 1-st order depends on the beam diameter. The minimum beam diameter is determined by the laser-induced damage threshold of the AOM crystal. The effect of the divergent beam formation in the acousto-optical modulator is either that of increasing the switching speed while maintaining the laser-induced damage threshold or exceeding the laser-induced damage threshold while keeping the switching speed constant.

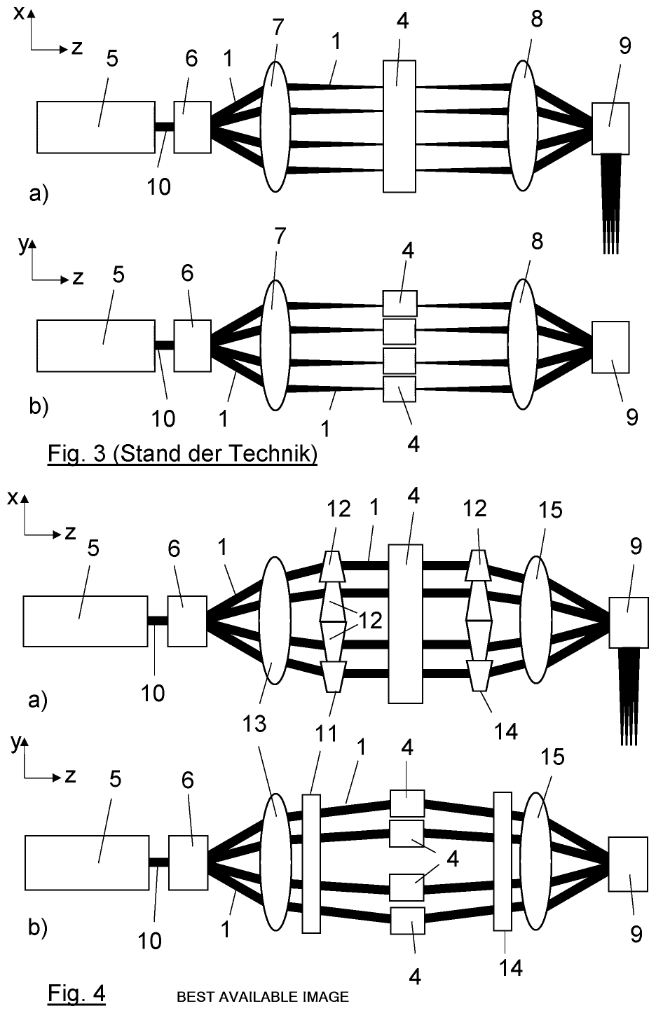

FIG. 3 shows a version of a laser material machining assembly according to the state of the art, in which a relay optic 7 with appropriate lenses is used for parallelisation of the sub-beams 1. The laser beam 10 emitted from the beam source 5 is split two-dimensionally (x- and y-direction) by the beam splitter 6 into multiple sub-beams. In this context, the sub-beams 1 are parallelised with a first relay optic 7 and guided through multichannel acousto-optical modulators 4. These sub-beams 1 are then merged suitably through a second relay optic 8 and directed into the machining plane via a 2D scanner 9. FIG. 3a further shows a side view of the assembly with the multichannel acousto-optical modulator 4 in this first dimension (x-direction). FIG. 4b shows a top view of the same assembly, in which the correspondingly numerous acousto-optical modulators 4 are visible.

In contrast to this, in the suggested assembly a relay optic is not used in front of the acousto-optical modulators 4 for parallelisation of the sub-beams 1. In this respect, FIG. 4a shows a side view, FIG. 4b shows top view of an example of the suggested assembly. Whereas due to the nature of the construction in the design according to FIG. 3 the lenses of the relay optic 7 must have the same diameter as the total width of the structure, this is no longer the case for the suggested assembly. The parallelisation in one of the two dimensions (x- and y-direction), into which the individual sub-beams 1 are split by the beam splitter 6, is effected in this example by the use of a prism stack 11, as is indicated schematically in the side view of the assembly in FIG. 4a. In this context, one prism 12 each deflects all of the beams in a beam plane that extends perpendicularly to the x-y plane respectively. All prisms 12 are combined to form an optical component, the prism stack 11, as is indicated in FIG. 4a. Because of this prism stack 11, the necessary collimation of the sub-beams in the acousto-optical modulators 4 is maintained during the parallelisation.

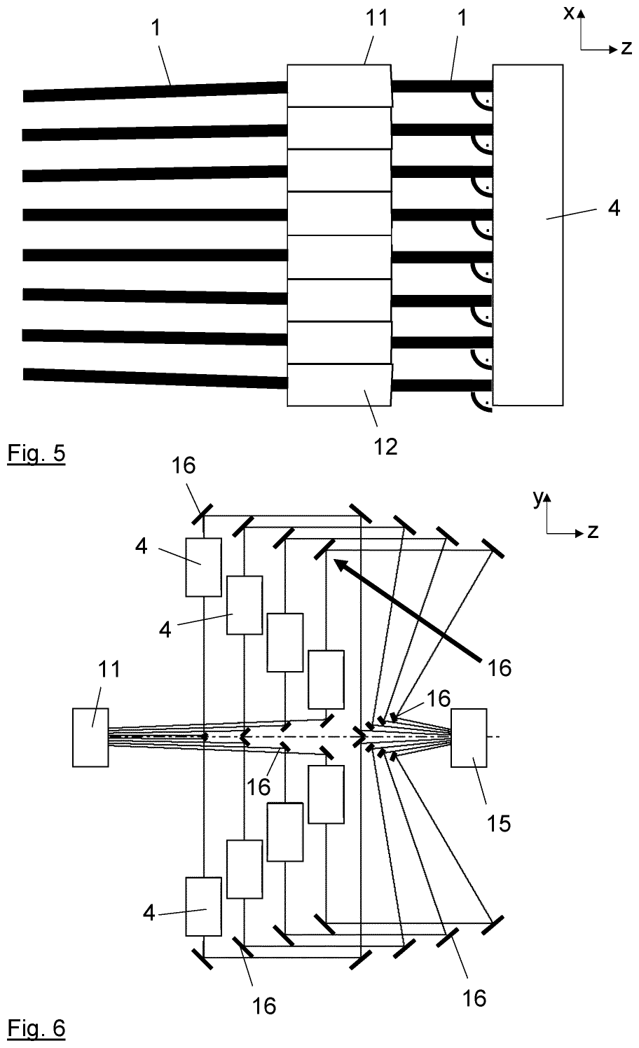

After exiting the beam source 5, the collimated raw beam 10 is split into a two-dimensional beam matrix with the aid of the beam splitting element of the beam splitter 6. In order to reduce the beam diameter, an afocal telescope 13 is used, which reduces all of the beams simultaneously. When the beams exit the first telescope 13, they are collimated, but divergent in both directions of the matrix extension, that is to say they are not parallel to each other. In order to separate the beam completely, the beam matrix is propagated freely in space. Then, a single prism 12 of the prism stack 11 for each beam plane of the beam matrix deflects the beams of this plane in such a way that they enter the acousto-optical modulators perpendicularly to the input plane of the acousto-optical modulators 4. This is indicated schematically in FIG. 5, which shows a side view of the assembly with the prism stack 11 and a multichannel acousto-optical modulator 4.

While the prism stack 11 parallelises all sub-beams 1 of the first dimension (x-direction), the sub-beams in the second dimension (y-direction) continue to diverge in the direction of the acousto-optical modulator 4, as is indicated in FIG. 4b. The individual acousto-optical modulators 4 can be suitably aligned and arranged in this second dimension to obtain the optimal angle of incidence of the sub-beams 1 on the crystals of the acousto-optical modulators 4 in this dimension.

The acousto-optical modulators 4 may also be rotated through 90°, arranged perpendicularly to the axis of propagation (dashed-dotted line in FIG. 6), in order to reduce the overall length of the assembly optic by reticulating the beam path. The beam path of the sub-beams 1 is then redirected by suitably arranged deflection element, for example deflection mirrors 16, as is shown for exemplary purposes in the top view of the suggested assembly in FIG. 6.

After passing through the acousto-optical modulators 4, the beam diameters of the sub-beams 1 are again adjusted suitably, preferably increased, with a second telescope 15, in order to achieve the smallest possible focus in the machining plane through a focusing optic arranged after the 2D scanner 9. The focusing optic is not shown in FIG. 4. A second prism stack 14 is also used to enable the distance between the individual laser spots in the machining plane to be adjusted independently of the second telescope 15.

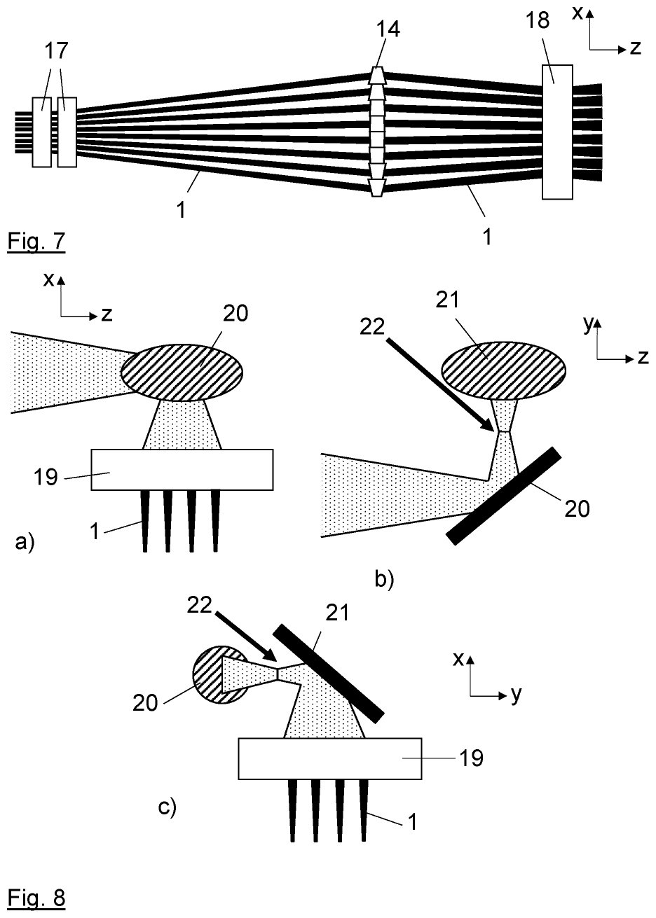

With this combination of second telescope 15 and second prism stack 14 it becomes possible to reconcile the contradictory conditions for spot diameter and spot distance on the workpiece and in the machining plane with the beam diameter and the beam distance in the acousto-optical modulators. In this context, the prism stack 14 may advantageously be integrated in the second telescope 15. This telescope 15 is equipped in known manner with an input optic 17 and an output optic 18, the second prism stack 14 being integrated between the input and the output optics. For this purpose, second prism stack 14 and second telescope 15 must be suitably tuned to each other. With the integration of this second prism stack 14, the additional degree of freedom is created that allows the spot distance in the machining plane to be adjusted independent of the beam diameter. FIG. 7 shows a corresponding side view of this assembly. When they exit the acousto-optical modulators, the sub-beams 1 are collimated and parallel. Integrating the prism stack 14 inside this second telescope 15 makes it possible for the spot diameter to be adjusted by the dimensioning of the input and output optics 17, 18 (and the distance thereof) and the spot distance to be adjusted independently of each other by the dimensioning of the prism stack 14.

After this second telescope 15, the two-dimensional scanner 9 deflects the entire beam matrix, as was suggested schematically earlier, in FIG. 4. FIG. 8 shows a more detailed view of this 2D galvanometer scanner 9, which consists in known manner of two mirrors that can be swivelled about axes that are perpendicular to one another, designated hereafter as X′ scanner 20 and Y′ scanner 21. In this context, FIG. 8 schematically shows a side view (FIG. 8a), a top view (FIG. 8b) and a front view (FIG. 8c) of this scanner. An objective (focusing optic 19) between the scanner 9 and the machining plane focuses the sub-beams 1 into the machining plane and onto the workpiece. In the present configuration, the second telescope 15 is dimensioned such that the intersection point 22 of all sub-beams 1 is always between the two deflection mirrors, that is to say between X′ scanner 20 and Y′ scanner 21. This intersection point 22 is suggested in FIG. 8. With this design, image errors that occur in the machining plane due to the beam deflection are prevented.

### LIST OF REFERENCE NUMERALS

1 Sub-beams
2 Workpiece
3 Divergent input beam
4 Acousto-optical modulator (AOM)
5 Beam source
6 Beam splitter
7 Relay optic before AOM
8 Relay optic after AOM
9 2D scanner
10 Collimated laser beam
11 First prism stack
12 Prism
13 First telescope
14 Second prism stack
15 Second telescope
16 Deflection mirror
17 Input optic
18 Output optic
19 Focusing optic
X′ scanner
21 Y′ scanner
22 Beam intersection point

1. Laser material machining assembly, having at least
one laser beam source (5), which emits a collimated laser beam (10),
a beam splitter (6), which splits the collimated laser beam (10) two-dimensionally into multiple sub-beams (1) that run non-parallel to each other at least in a first dimension,
a first optical assembly, which aligns the sub-beams (1) in the first dimension parallel to each other,
a modulating device with a plurality of acousto-optical modulators (4), which are of multichannel design in the first dimension and with which the individual sub-beams (1) can be modulated independently of each other, and
a dynamic beam deflection device (9), with which the sub-beams (1) are dynamically deflectable into two directions aligned perpendicularly to each other and can be guided over a machining plane,
wherein the first optical assembly has several first prisms (12), which are designed and arranged such that the sub-beams (1) are aligned in parallel to each other in the first dimension upon passing through the first prisms (12) by means of a double diffraction in each case.

2. Assembly according to claim 1,
characterized in that
the first prisms (12) are connected rigidly to each other to form a first prism stack (11).

3. Assembly according to claim 1 or 2,
characterized in that
the first optical assembly also includes a first, preferably a focal telescope (13), by which a beam diameter of the sub-beams (1) is reduced.

4. Assembly according to claim 1, characterized in that
the dynamic beam deflection device (9) includes two mirrors (20, 21), which can be swivelled about axes that are aligned perpendicular to one another.

5. Assembly according to claim 1, characterized in that
a second optical assembly is arranged between the modulating device and the dynamic beam deflection device (9), which second assembly deflects the sub-beams (1) exiting the modulating device in such manner that a mutual distance between the sub-beams (1) in the machining plane is reduced or enlarged.

6. Assembly according to claim 5, characterized in that
the dynamic beam deflection device (9) includes two mirrors (20, 21), which can be swivelled about axes that are aligned perpendicular to one another, wherein the second optical assembly is designed such that the sub-beams (1) intersect between the two swivelling mirrors (20, 21) of the dynamic beam deflection device (9).

7. Assembly according to claim 5,
characterized in that
the second optical assembly includes a second telescope (15) with an input optic (17) and an output optic (18), wherein the second telescope (15) includes an assembly of a plurality of second prisms (12) between the input and the output optics (17, 18), by which the mutual distance between the sub-beams (1) in the machining plane is reduced or enlarged.

8. Assembly according to claim 7,
characterized in that
the second prisms (12) are rigidly connected to each other, forming a second prism stack (14).

9. Assembly according to claim 1, characterized in that the beam splitter (6) is formed by at least one diffractive optical element.

10. Assembly according to claim 1, characterized in that
the acousto-optical modulators (4) are aligned such that the sub-beams (1) of each beam plane in which the sub-beams (1) are aligned parallel to each other are perpendicularly incident on the acousto-optical modulators (4).

11. Assembly according to claim 1, characterized in that
sub-beams (1) are guided between the beam splitter (6) and the dynamic beam deflection device (9) via multiple deflecting elements (16) to reduce the installation space for the assembly through a reticulated beam path.
